(19) United States
(12) Patent Application Publication
(10) Pub. No.: US 2015/0373565 A1
(43) Pub. Date: Dec. 24, 2015

(54) QUALITY OF EXPERIENCE WITHIN A CONTEXT-AWARE COMPUTING ENVIRONMENT

(71) Applicant: Samsung Electronics Co., Ltd., Gyeonggi-do (KR)

(72) Inventor: Saeid Safavi, San Diego, CA (US)

(21) Appl. No.: 14/641,487

(22) Filed: Mar. 9, 2015

Related U.S. Application Data
(60) Provisional application No. 62/015,281, filed on Jun. 20, 2014.

(51) Int. Cl. H04W 24/08; H04W 72/04

(52) U.S. Cl. CPC H04W 24/08; H04W 72/0453

(57) ABSTRACT

Improving Quality of Experience (QoE) within a context-aware computing environment includes continuously receiving device data, receiving user data, and generating, using a processor, a QoE model using the device data and the user data. Using a processor, a predicted QoE is determined using the QoE model. A notification for improving a current QoE from the predicted QoE is provided.

### CROSS-REFERENCE TO RELATED APPLICATIONS

This application claims the benefit of U.S. Application No. 62/015,281 filed on Jun. 20, 2014, which is fully incorporated herein by reference.

### TECHNICAL FIELD

This disclosure relates to improving Quality of Experience within a context-aware computing environment.

### BACKGROUND

Quality of Experience, or QoE, is a measure of user experience with a particular service or product such as voice communication, television broadcasts, or the like. While QoE is intended as a technique for measuring the quality of experience for an end user of a service or product, the data relied upon to calculate QoE is objective data. One result is that for a given service, the data used to determine QoE is largely technology dependent and obtained using non-intrusive network level quality estimation techniques. Another result is that available QoE determination techniques may not reflect real time conditions experienced by the user.

### SUMMARY

A method includes continuously receiving device data, receiving user data, and generating, using a processor, a Quality of Experience (QoE) model using the device data and the user data. The method may include determining, using the processor, a predicted QoE using the QoE model and providing a notification for improving a current QoE from the predicted QoE.

A system includes a processor programmed to initiate executable operations. The executable operations include continuously receiving device data, receiving user data, and generating a QoE model using the device data and the user data. The executable operations also include determining a predicted QoE using the QoE model and providing a notification for improving a current QoE from the predicted QoE.

A computer program product includes a computer readable storage medium having program code stored thereon. The program code is executable by a processor to perform a method. The method includes continuously receiving device data using the processor, receiving user data using the processor, and generating, using the processor, a QoE model using the device data and the user data. The method further includes determining, using the processor, a predicted QoE using the QoE model and providing, using the processor, a notification for improving a current QoE from the predicted QoE.

This Summary section is provided merely to introduce certain concepts and not to identify any key or essential features of the claimed subject matter. Many other features and embodiments of the invention will be apparent from the accompanying drawings and from the following detailed description.

### BRIEF DESCRIPTION OF THE DRAWINGS

The accompanying drawings show one or more embodiments; however, the accompanying drawings should not be taken to limit the invention to only the embodiments shown. Various aspects and advantages will become apparent upon review of the following detailed description and upon reference to the drawings in which:

FIG. 1 is a diagram illustrating an exemplary computing environment;

FIG. 2 is an exemplary architecture for a data processing system;

FIG. 3 is an exemplary software architecture for a communication device;

FIG. 4 is a block diagram illustrating an exemplary implementation of a client application;

FIG. 5 is a flow chart illustrating an exemplary method of determining Quality of Experience (QoE);

FIG. 6 is an exemplary QoE map of predicted QoEs; and

FIG. 7 is an exemplary message flow diagram illustrating communication between devices and a QoE processing system.

### DETAILED DESCRIPTION

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to improving Quality of Experience (QoE) within a context-aware computing environment. In accordance with the inventive arrangements disclosed herein, a variety of different data types may be collected and used to generate a QoE model. The QoE model may be generated in real time, for example, while a user, using a device, interacts with the context-aware computing environment. Once the QoE model is generated, a predicted QoE may be determined.

In one aspect, the different data types used to generate the QoE model may include device data and user data. Device data may include data that is objective and measured by a device. User data may include data describing a user such as a user profile, a user preference, or other subjective data including user feedback provided by a user. The QoE model may be generated using both the device data and the user data.

In another aspect, one or more predicted QoEs may be determined. A predicted QoE may be determined using the QoE model. For example, the QoE model may be used to determine a predicted QoE without using any additional user data. The QoE model may determine the predicted QoE using further received device data. A notification for improving a current QoE from the predicted QoE may be generated and/or provided.

The inventive arrangements described herein may be implemented as a method or process performed by a data processing system. In another aspect, the inventive arrangements may be implemented as an apparatus such as a data processing system having a processor. The processor, upon executing program code, may perform one or more operations described herein. In one aspect, the apparatus may be a client-side device. In another aspect, the apparatus may be server-side device. Exemplary devices may include, but are not limited to, a communication device whether mobile or not, an appliance, a network communication node, computing system, or the like. In still another aspect, the inventive arrangements may be implemented as a non-transitory computer-readable storage medium storing program code that, when executed, causes a processor and/or a system to perform and/or initiate a method or process.

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

FIG. 1 is a diagram illustrating an exemplary computing environment (environment) 100. Environment 100 may be a context-aware computing environment. A context-aware computing environment is one where the context or manner in which a user interacts with one or more nodes within and/or external to the environment through one or more devices may be observed and/or determined.

Environment 100 may also be a heterogeneous communication environment. A heterogeneous communication environment refers to a networked communication system having a plurality of different communication channels. Environment 100, for example, may include one or more devices capable of communicating over a plurality of different communication channels. While different devices may communicate over different communication channels, it should be appreciated that some devices may communicate over a plurality of different selectable communication channels, e.g., a mobile device that is operable to communicate over Bluetooth, IEEE 802.11x, and/or Near Field Communication (NFC).

In one aspect, the term “communication channel” means a particular physical transmission medium such as a wire or an optical cable. In another aspect, the term “communication channel” means a particular logical connection and/or a particular communication protocol. In still another aspect, the term “communication channel” means a particular radio access technology (RAT). Examples of different RATs may include, but are not limited to, NFC, Bluetooth, 60 Hz (e.g., over power lines), WiFi (IEEE 802.11x in reference to any of the 802.11 family of communication protocols), Worldwide Interoperability for Microwave Access (WiMax), Long-Term Evolution (LTE), Universal Mobile Telecommunications System (UMTS), Global System for Mobile/General Packet Radio Service (GSM/GPRS), or the like.

FIG. 1 illustrates a floor plan view of a structure 102. Structure 102 may be a habitable structure such as a business establishment, e.g., an office, a personal dwelling, or the like. Structure 102 is provided for purposes of illustration only and is not intended as a limitation of the inventive arrangements disclosed herein. For example, structure 102 may include multiple floors, fewer rooms, more rooms, or the like.

In the example of FIG. 1, structure 102 includes a plurality of different rooms. Within one room, structure 102 includes a QoE processing system (system) 104. In one aspect, system 104 is implemented as an edge device. The edge device may be implemented as a modem, a router, a wireless access point (WAP), or a combination modem and/or router with WAP. Other examples of edge devices in which system 104 may be implemented include, but are not limited to, a network-enabled computer, a network-enabled television, a network-enabled multimedia system, a set-top box, a printer, network-enabled appliances, or the like.

In general, system 104 includes a processor and a data storage device. The data storage device may store a data structure including device data and user data received from one or more other devices. System 104 is configured to generate a QoE model using the device data and the user data in real time while operating in environment 100. The device data may include network data and application data to be described in greater detail herein. The device data further may include metadata. System 104 further may determine one or more predicted QoEs using the QoE model. The predicted QoEs may be used to improve a current QoE for a user.

System 104 is communicatively linked to a network 106. Network 106 is the medium used to provide communication links between system 104 and one or more other systems located outside, or external to, structure 102. Network 106 may include connections, such as wired communication links, whether electrical or optical, and wireless communication links. Network 106 may be implemented as, or include, any of a variety of different communication technologies such as a Wide Area Network (WAN), a Local Area Network (LAN), a wireless network whether WAN or LAN, a mobile network, a Virtual Private Network (VPN), the Internet, the Public Switched Telephone Network (PSTN), or the like. It should be appreciated that any devices may communicate directly with one or more nodes in, or connected to, network 106 without utilizing system 104 depending upon the particular communication channel used.

An information processing system 108 is coupled to network 106. Information processing system 108 may include one or more networked computing systems executing appropriate operational software and one or more applications. For example, information processing system 108 may be implemented using one or more servers accessible through network 106 including, but not limited to, a cloud computing infrastructure, one or more virtual servers, or combinations thereof.

System 104 is depicted as an edge device or one that is on-premises of structure 102. As an edge device, system 104, for example, may backhaul communication traffic through wired or wireless communication links. In another aspect, however, system 104, i.e., the QoE processing system, may be implemented in a different computing device. In one example, the QoE processing system may be implemented within information processing system 108. Thus, the QoE prediction system may be implemented off-premises from structure 102 such as within a network accessible server or plurality of networked servers.

As pictured, structure 102 includes a plurality of different devices 110, 112, 114, 116, 118, 120, 122, 124, 126, and 128. Exemplary device types may include sensors, appliances, and communication devices. It should be appreciated that in some cases, one or more sensors may be incorporated within an appliance and/or a communication device. In other cases, one or more sensors may be standalone sensors.

For example, devices 110, 112, 114, 116, and 118 may be implemented as sensors. The sensors may be communicatively linked to system 104 through a wired communication link and/or a wireless communication link. For purposes of illustration, devices 110, 112, 114, and 116 are communicatively linked to system 104 through wireless communication links. Device 118 is communicatively linked to system 104 through a wired communication link represented by a dashed line.

Devices 110-118 may be implemented as any of a variety of different sensor types. Exemplary sensor types include, but are not limited to, temperature sensors, audio level (e.g., noise) sensors, motion sensors, power outage sensors, water leakage sensors, gas leakage sensors, smoke detectors (sensors), intruder sensors (e.g., alarm and/or security systems), humidity sensors, or the like. Other exemplary sensor types may include biological sensors such as heart rate sensors, blood pressure sensors, or the like. Each of devices 110-118 may include a network adapter, whether for wired or wireless communication as the case may be, to communicate with system 104.

In one aspect, devices 110-118 may be configured to generate smart home type of device data. Exemplary device data generated by devices 110-118 considered to be smart home type of data may include, but is not limited to, ambient temperature data, ambient noise control data, ambient lighting data, motion detection data, intruder or burglary detection data, smoke detection data, water or gas leakage detection data, or the like. Ambient temperature data may include, but is not limited to, airflow data, temperature at one or more device locations, user activity, humidity, and the like. Ambient noise control data may include, but is not limited to, noise level of various devices such as appliances, current noise level of activity in an area surrounding the audio sensor, e.g., a general noise level from any active devices in proximity of the sensor, or other audio levels. Ambient lighting data may include, but is not limited to, the amount of natural light from outdoors such as whether sunny, cloudy, etc.), the status of blinds or drapes (e.g., being opened or closed), the time of day, and the current lighting condition within structure 102. It should be appreciated that any of the aforementioned data items generated by a device may be accompanied by, or include, time stamp data and/or location data. The aforementioned examples of smart home data specify physical conditions within a structure such as a dwelling or a place of business.

Devices 120, 122, 124, and 126 may be implemented as appliances. Like system 104, devices 120, 122, 124, and 126 may also be considered edge devices in that these devices may backhaul communication traffic through wired or wireless communication links. In this regard, it should be appreciated that system 104, i.e., the QoE processing system, may be implemented within any one of devices 120, 122, 124, or 126. For purposes of illustration and example, appliance 120 may be dishwasher. Appliance 122 may be a clothes washing machine, while appliance 124 may be a clothes dryer. Appliance 126 may be a television. Other examples of appliances that may be network-enabled may include, but are not limited to, refrigerators, freezers, climate control systems such as air-conditioning and/or heating systems, audio systems, video systems, set-top boxes or other television network support appliances that access Internet content, etc.

For purposes of illustration, device 120 is coupled to system 104 through a wireless communication link, while devices 122, 124, and 126 are coupled to system 104 through wired communication links represented by dashed lines. It should be appreciated that the type of communication link, e.g., wireless or wired, between an appliance and system 104 is not intended as a limitation of the inventive arrangements disclosed herein.

Device 128 may be implemented as a communication device. Communication device 128 may be a mobile phone, e.g., a smart phone, a tablet computing device that is wireless-enabled, or the like. In one aspect, communication device 128 may include one or more different wireless transceivers. For example, communication device 128 may be configured to communicate via WiFi, Bluetooth, NFC, and/or any of a variety of known mobile and/or cellular communications technologies.

Devices 120-128 may be operative to provide device data to system 104. Device data may include network data and application level data. Network data may include, but is not limited to, information such as jitter, delay, bit error rate (BER), received signal strength indication (RSSI), packet success rate, packet failure rate, spectral information, temporal information, link speed, service metadata, and the like. In one aspect, service metadata may specify a type of service being performed. Application level data may include, for example, content type, content features, a current operating state, and the like. Content type may indicate streaming audio, streaming video, other data, etc. Content features may specify, at least in the case of video content, a movement type in the content such as fast, slow, gentle, a particular program (e.g., movie or television show) being played, a recording or program being played, etc. The current operating state may indicate what the particular device is doing at the present moment, e.g., in real time, such as performing a dishwashing cycle, drying dishes, performing a clothes washing cycle, performing a clothes drying cycle, or the like. In another aspect, service metadata may specify service type, and one or more items of application data such as content type and/or quality of service.

In some cases, overlap may exist between device data collected by a sensor type of device and an appliance type of device. For example, air-flow and/or other temperature data may be obtained using a standalone sensor or may be collected by one or more sensors included in a climate control system appliance. Further, each device may collect only a subset of the various data items noted. For example, a dishwasher will not provide data regarding content being played, but may indicate whether the device is actively performing an operation at a given time. The device data further may specify a location. Communication device 128 may provide application level data and network data. Regarding application level data, communication device 128 may send data such as content type being played, operating state, the particular applications that may be executing, and/or the operating state in existence within such applications. The inventive arrangements disclosed herein are not intended to be limited by the particular type of device used to collect the device data.

One or more of the described devices, e.g., device 126 and/or communication device 128, may send user data. User data may include, but is not limited to, user preferences and user feedback. User preferences may include an initial preference for one or more services. The user preferences may be specified in a user profile maintained within the device. The user profile may be created by the device based upon input received from the user and/or from historical data stored within the device. For example, user preferences within a user profile may indicate user privacy preferences such as privacy restrictions for sharing particular data and how such data is to be shared or transmitted, price preference for a service, personalization options for a service, a user sound level preference, a user lighting preference, a user temperature preference, or the like.

User feedback may be any user input that is obtained periodically, intermittently, in real time, or the like relating to a particular service. Exemplary types of user feedback may include, but are not limited to, a mean opinion score (MOS), a perceived network quality, accessibility, performance, sustainability, location of the user when user data is obtained, or the like. For example, a user may provide an MOS describing a streaming state of content delivered to a device. The MOS may indicate the quality of the received content as determined by the user. Regarding streaming video, the MOS, for example, may be set to 5 to indicate perfect quality video, 4 to indicate some blurriness in the video, 3 to indicate blockiness in the video, 2 to indicate stalling in the video, and 1 to indicate a black frame or no video playing.

As defined herein, a “service” refers to a service and/or a product. For example, a service may include a Web-based service, a service implemented using a client-server architecture, a communication service such as telephony whether mobile or not, a video streaming service, an application or device executing an application, or the like.

In operation, system 104 receives device data from one or more or all of devices 110-128, including device data from various combinations of devices 110-128. System 104 further may receive user data from communication device 128, device 126, or another device through which the user may interact and which is operative to receive user input. System 104 may generate a QoE model. System 104 may generate the QoE model using a machine learning technique that utilizes one or more portions of the device data and one or more portions of the user data.

System 104 may utilize the QoE model to determine one or more predicted QoEs based upon further received device data. In one aspect, each predicted QoE may be specific to a particular communication channel, specific to a particular time, and/or specific to a particular location, e.g., a location of the user. For example, a plurality of predicted QoEs may be determined and used to create a predicted QoE map, where for a given time and location and optionally a given communication channel, the predicted QoE map indicates the various predicted QoEs expected throughout a geographic area such as structure 102.

In a further aspect, system 104 may send a notification to a user, e.g., to a device of the user such as communication device 128 and/or appliance 126. In one aspect, the notification may be informative in nature in that the notification provides instructions for the user to implement to improve QoE for a given service. In another aspect, the notification may be, or include, one or more instructions for communication device 128 or another device to implement. For example, the notification may be an instruction for communication device 128 to switch from a first communication channel to a second communication channel in order to improve current QoE according to one or more of the predicted QoEs.

In another example, the notification may be a message indicating that since the user is watching a program on the television, the start time of the dishwasher may be delayed to reduce noise in structure 102 to improve the television viewing QoE. In one example, the notification may be informative such as in the case where the notification indicating that the dishwasher should not be run is sent to communication device 128. In another example, while a notification may be sent to communication 128, another notification may be sent to the dishwasher with an instruction not to activate until a particular time in the future, such as after content being viewed or otherwise consumed by the user has finished playing.

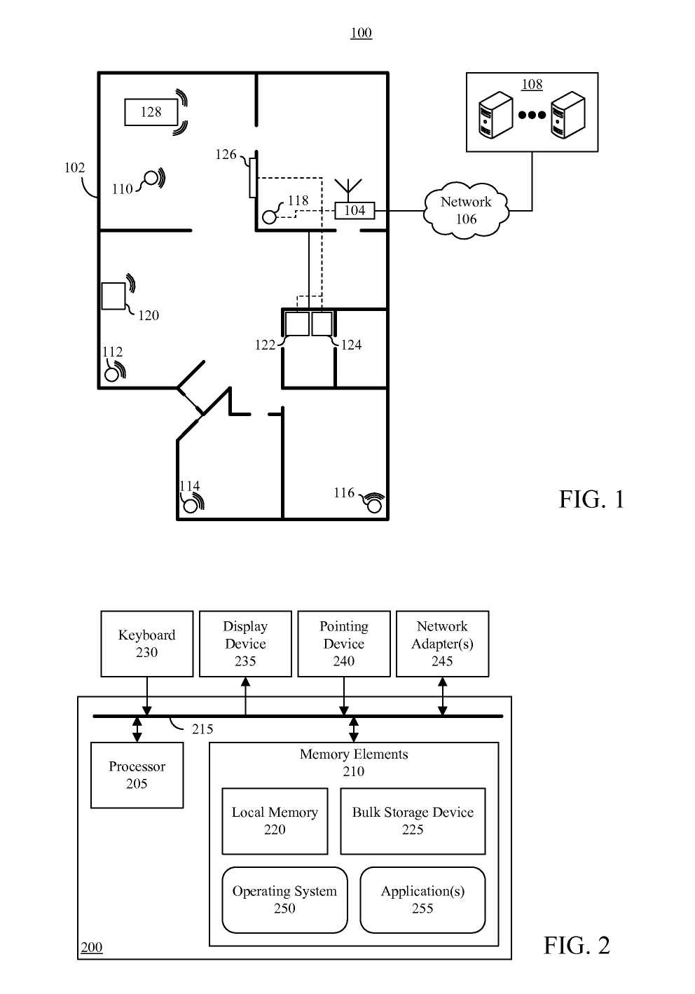

FIG. 2 is an exemplary architecture 200 for a data processing system. Architecture 200 may be used to implement any of a variety of different devices such as communication device 128, one or more computing systems of information processing system 108, system 104, or the like. Architecture 200 may be used to implement any of a variety of systems and/or devices that include a processor and memory and that are capable of performing the operations described within this disclosure. In some cases, the particular device implemented using architecture 200 may include fewer components or more components than shown. Further, the particular operating system and/or application(s) included may vary.

As pictured, architecture 200 includes at least one processor, e.g., a central processing unit (CPU), 205 coupled to memory elements 210 through a system bus 215 or other suitable circuitry. Architecture 200 stores program code within memory elements 210. Processor 205 executes the program code accessed from memory elements 210 via system bus 215. Memory elements 210 include one or more physical memory devices such as, for example, a local memory 220 and one or more bulk storage devices 225. Local memory 220 refers to random access memory (RAM) or other non-persistent memory device(s) generally used during actual execution of the program code. Bulk storage device 225 may be implemented as a hard disk drive (HDD), solid state drive (SSD), or other persistent data storage device. Architecture 200 may also include one or more cache memories (not shown) that provide temporary storage of at least some program code in order to reduce the number of times program code must be retrieved from bulk storage device 225 during execution.

Input/output (I/O) devices such as a keyboard 230, a display device 235, and a pointing device 240 may optionally be coupled to architecture 200. In some cases, one or more of the I/O devices may be combined as in the case where a touchscreen is used as display device 235. In that case, display device 235 may also implement keyboard 230 and pointing device 240.

The I/O devices may be coupled to architecture 200 either directly or through intervening I/O controllers. One or more network adapters 245 may also be coupled to architecture 200 to enable architecture 200 to become coupled to other systems, computer systems, remote printers, and/or remote storage devices through intervening private or public networks. Modems, cable modems, Ethernet cards, and wireless transceivers are examples of different types of network adapter 245 that may be used with architecture 200. Depending upon the particular device implemented with architecture 200, the specific type of network adapter, or network adapters as the case may be, will vary.

As pictured in FIG. 2, memory elements 210 store an operating system 250 and one or more applications 255. In one aspect, operating system 250 and application(s) 255, being implemented in the form of executable program code, are executed by architecture 200. As such, operating system 250 and application(s) 255 may be considered an integrated part of architecture 200. Operating system 250, application(s) 255, and any data items used, generated, and/or operated upon by architecture 200 are functional data structures that impart functionality when employed as part of a system implemented using architecture 200.

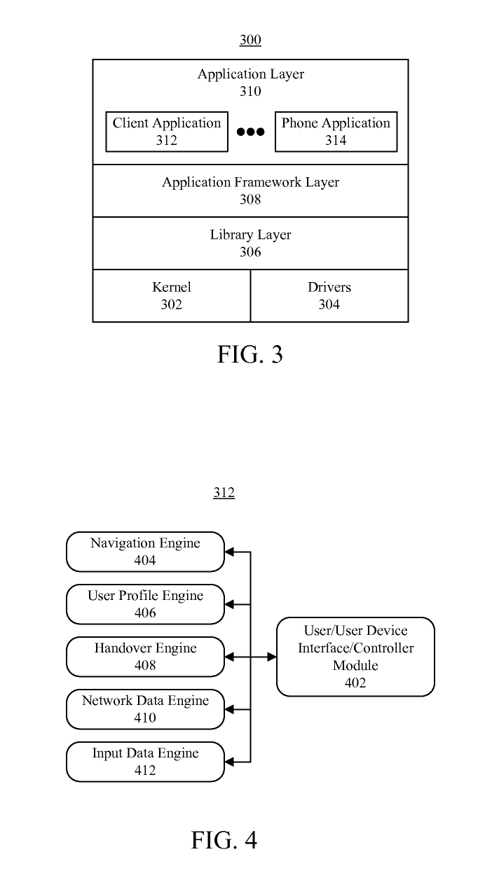

FIG. 3 is an exemplary software architecture 300 for communication device 128 of FIG. 1. Communication device 128 may execute a client application 312 that executes cooperatively with an application executing in system 104. It should be appreciated that FIG. 3 is provided for purposes of example only and is not intended as a limitation of the inventive arrangements disclosed herein. The particular software architecture used by communication device 128 will vary in accordance with the particular type of communication device used.

As pictured, software architecture includes a kernel 302, one more drivers 304, a library layer 306, and an application framework layer 308. Software architecture 300 further includes an application layer 310. Within application layer 310, architecture 300 includes a client application 312 and a phone application 314. Client application 312 may include program code that, when executed by communication device 128, causes communication device 128 to perform the various operations described herein such as collect user data and device data and provide one or both to system 104.

FIG. 4 is a block diagram illustrating an exemplary implementation of client application 312 of FIG. 3. Client application 312 may include a plurality of program code modules. As pictured, client application 312 may include a user/user device interface/controller module 402 configured to load and run one or more sub-application engines. User/user device interface/controller module 402 may read user input and/or user device data such as network level data and/or application level data. In this example the network level data may specify network quality data. The network quality data may be collected using a network adapter driver (e.g., drivers 304) as discrete events in the time and space domains. A graphical user interface (GUI) may optionally be included as part of user/user device interface/controller module 402.

One or more sub-application engines may be included for performing different operations. In the example of FIG. 4, the sub-application engines include a navigation engine 404, a user profile engine 406, a handover engine 408, a network data engine 410, and an input data module 412. Navigation engine 404 may provide the user with real-time location services and support different applications that may be combined with network data engine 410. For instance, through usage of application programming interfaces (APIs) provided through a standard development kit (SDK), navigation engine 404 may support one or more mapping services. In operation, for example, navigation engine 404 may combine a map application and/or service with routing software for generating directions and include forward and reverse geocoding software to determine location coordinates from addresses and/or determine an address from location coordinates.

User profile engine 406 is configured to process user data to produce a distinct user profile for communication device 128. The user profile, which has been described above as part of the user data, may be defined by one or more parameters or the combination of such parameters. Exemplary parameters included in the user profile may include, but are not limited to, user equipment identifiers, the user location, user age, user interests, user hobbies, user health status, user status history, and/or the like. The user profile, as generated by user profile engine 406, may include both real time and non-real time parameters. Non-real time parameters such as user interests, hobbies, or the like may be stored in communication device 128. Real time parameters such as user location may also be stored in communication device 128 and updated from time-to-time, periodically, or responsive to particular events. The user profile may be provided to system 104 as part of the user data.

Handover engine 408 may be configured to perform a handover operation where communication device 128 switches from performing an operation using a first communication channel to performing the operation on a second and different communication channel for a same service without interrupting the particular operation or service. For example, while streaming video content or conducting a voice call, communication device 128 may switch from conducting the streaming and/or call operations from a first communication channel such as a mobile communication channel to a second communication channel such as an 802.11x communication channel. In one aspect, handover engine 408 may implement a handover operation in response to an instruction and/or notification from system 104.

Network data engine 410 may be configured to collect network level data for communication device 128. As discussed, network level data for communication device 128 is considered part of the device data. Input data engine 412 is configured to gather input data that is read by communication device 128 and/or captured by communication device 128. Examples of input data may include pictures, video, and barcode data, Quick Response (QR) data, or the like. The input data may be sent from communication device 128 as part of the user data.

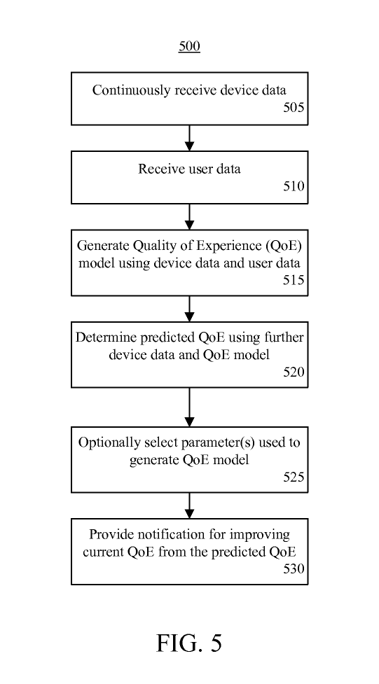

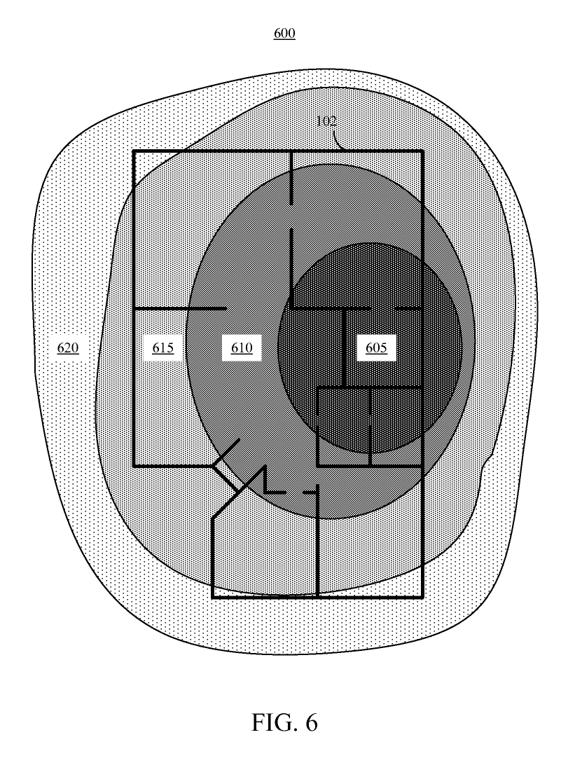

FIG. 5 is a flow chart illustrating an exemplary method 500 of determining QoE. Method 500 may be implemented by a QoE prediction system such as system 104 as described with reference to FIGS. 1 and 2. As discussed, system 104 may be implemented within an edge device or within a network accessible computing system.

In block 505, the system continuously receives device data. The system may receive device data from any of the various devices described with reference to FIG. 1. A device may send device data periodically, responsive to a request or another event, from time-to-time, or the like. As noted, device data includes objectively measurable data. For example, device data may include network data, application data, and/or metadata. In block 510, the system receives user data. In one aspect, user data is subjective data from a user. The user data may be received from one or more communication devices and/or one or more appliances. As discussed, the user data may include user preference data including an initial preference, real time user feedback, and the like.

In block 515, the system generates a QoE model. The system generates the QoE model using the device data and the user data. In one aspect, the system receives a vector specifying device data represented as “X,” and user data represented by “Y.” Both X and Y may be used as training data to generate a QoE model using a machine learning technique in real time as received. For example, the machine learning technique may be a Decision Tree Induction Technique. Inclusion of the user data, e.g., subjective data, may improve the accuracy of the resulting QoE model and predicted QoEs, particularly over other techniques that rely solely upon objective data. Having generated the QoE model, a predicted QoE may be obtained purely as a function of X, without requiring Y.

Any of a variety of known decision tree type machine learning techniques may be used to generate the QoE model. In one aspect, decision tree techniques such as the ID3 family of decision tree techniques as disclosed in J. R. Quinlan, “Induction of Decision Trees,” Machine Learning, vol. 1, March 1986, pp. 81-106, may be used as the machine learning technique. In another aspect, a modified version of the “Induction of Decision Trees” technique may be used as the machine learning technique as described in J. R. Quinlan, “C4.5 Programs for Machine Learning,” Morgan Kaufmann (2003). The Induction of Decision Trees technique and the C4.5 Programs for Machine Learning technique are examples of batch processing techniques that may be applied.

In still another aspect, a Hoeffding Tree based technique may be used for the machine learning technique as disclosed in P. Domingos and G. Hulten, “Mining High-Speed Data Streams,” Proceedings of the Sixth ACM SIGKDD International Conference on Knowledge Discovery and Data Mining, 2000, pp. 71-80. The Mining High-Speed Data Streams technique is an example of an online technique where the training data need not remain stored in memory once processed in a single pass and the QoE model is generated.

In block 520, the system determines a predicted QoE. In one aspect, the system determines the predicted QoE using the QoE model and using additional device data. For example, device data received subsequent to QoE model generation may be used. The additional device data is not part of the training data, but rather is received in real time subsequent to QoE model generation. By applying the additional data received to the QoE model, a predicted QoE is determined.

The system may determine more than one predicted QoE. In one aspect, each QoE is time specific, location specific, communication channel specific, and service specific. Accordingly, for a given time, location, communication channel, and/or service, one or more predicted QoEs may be determined. A plurality of QoEs for a given service and/or communication channel and different locations may be plotted on a coordinate system representing a geographic area such as structure 102. The resulting plot is a “map” indicating QoE on a per-location, basis for a given time, and for a given service.

In block 525, the system optionally selects the particular parameters to be used in creating the QoE model. The parameters used to create the QoE model include one or more selected parameters of the available parameters of user data and one or more selected parameters of the available parameters of device data. For example, the system may select one or more different parameters for use in QoE model generation based upon a determined level of accuracy of the QoE model. In general, accuracy of the QoE model may be determined by applying the QoE model to known test data and comparing the output of the QoE model, e.g., a QoE or a predicted QoE, with an expected output.

Accuracy of the QoE model may be determined from time-to-time or periodically using known testing and evaluation techniques at which point the system may vary the parameters used in generating the model, for example, responsive to the QoE model having an accuracy below a threshold level of accuracy. In another example, parameters used in creating the QoE model may be continuously updated and used in the case where the change results in an increased level of accuracy for the QoE model.

In one aspect, the system may utilize a machine learning technique as described herein to select the particular parameters that are used to generate the QoE model. For example, the machine learning technique may determine that packet success rate, when incorporated into the QoE model, provides a greater level of accuracy than incorporating link speed. Accordingly, in block 515, the system may utilize packet success rate for the QoE model and not link speed.

In another aspect, the system may utilize a machine learning technique to select a granularity of one or more parameters of a same parameter type to be used in generating the QoE model. The term “granularity,” as applied to parameter collection for QoE model generation and/or QoE prediction may mean the frequency of data collection for a parameter, e.g., sample rate, quality of the data collected, or the like. For example, the system, by utilizing a machine learning technique, may determine the measurement frequency for one or more parameters of the device data and/or dwell time to meet particular goals such as not using too much system memory, not consuming too much power, or the like. Dwell time, for example, is the amount of time a device spends in a same stage of a process or an operating state such as data collection and/or data transmission. In illustration, the system may determine that the accuracy of the QoE model is not reduced when the sample rate of a selected parameter is reduced. In response, the system may adjust the model to utilize data points for the parameter that are obtained at larger intervals to reduce the amount of data that needs be collected and/or sent from the source device.

In general, it should be appreciated that the machine learning techniques utilized for QoE model generation and/or parameter selection may be adaptive. For example, the system may change the particular parameters used to generate the QoE model over time based upon accuracy of the QoE model. The system may change the granularity of one or more parameters of the system based upon accuracy of the QoE model. In that case, the system may notify one or more devices to collect and/or send data with increasing and/or decreasing frequency or increasing and/or decreasing level of detail in accordance with the particular parameter selections made. Further, as part of adapting the QoE model over time, the relative importance of one or more parameters used to generate the QoE model may change over time. Accordingly, within the decision tree structure of the QoE model, the ordering of nodes and/or the structure of the tree used to determined predicted QoEs may be changed.

In block 525, the system provides a notification for improving a current QoE from the predicted QoE. In one aspect, the current QoE is a QoE calculated for the user using the QoE model given the user's current location, the current time, and the current device data available. A predicted QoE, for example, may be a QoE where one or more parameters of either device data and/or user data, e.g., location, are different from the particular parameters of device data and/or user data used to calculate the current QoE. In another aspect, the current QoE may be obtained from the user in the form of user feedback whether explicitly specified by the user as an input to a device or determined from other user data such as facial expressions, health metrics, or the like.

The notification may be provided to the communication device or another device such as a television or other appliance. In one aspect, the notification may be informative and provide the user with a suggestion or instructions for improving quality of service. For example, the system may send a QoE map to a device used by the user showing locations or other suggestions where predicted QoEs are greater than the current QoE for the user given a particular time, location, and/or service. The QoE map may show predicted QoEs for the service using a different communication channel that is currently being used. In another aspect, the notification may include an instruction that may be executed by the particular device or devices receiving the notification.

FIG. 6 is an exemplary QoE map 600 of predicted QoEs. In one aspect, QoE map 600 may be a heat map. In general, a heat map is a graphical representation of data where the individual values contained in a matrix are represented as colors. For ease of illustration, QoE heat map 600 is shown with shaded regions 605, 610, 615, and 620. Region 605 represents the region with the highest predicted QoEs for a given service. Region 610 has the second highest predicted QoEs for the service. Region 615 has the third highest predicted QoEs for the service. Region 620 has the lowest predicted QoEs for the service.

In another example, the coloring or shading of regions 605, 610, 615, and 620 may be continuous with more gradual adjustment where one region tends to flow into the next with continually changing coloration and/or shading. FIG. 6 may also be illustrative of a contour type of QoE map, where the boundaries between different QoE regions are more definitively outlined.

As discussed, the predicted QoE values represented by QoE map 600 represent predicted QoE values for a particular service at a particular time. As illustrated in FIG. 6, the predicted QoE values represented by QoE heat map 600 are location specific. The particular service for which predicted QoEs are illustrated on FIG. 6 may vary according to service.

In one example, the predicted QoEs of QoE map 600 may represent predicted QoEs for general comfort level in a home that accounts for user preference relating to one or more of audio level, temperature, lighting, and/or any combination thereof. Further, the QoEs may be specific to only temperature, only to lighting, or only to audio level. In another example, the predicted QoEs of QoE map 600 may be for viewing experience of audiovisual material that accounts for the user's preference for audiovisual quality, temperature, ambient noise level in structure 102, network level data, application level data, and/or the like.

In still another example, QoE map 600 may specify predicted QoEs for a particular type of video content. For example, QoE map 600 may specify predicted QoEs for video content with gentle or moderate movement, for video content with rapid or fast movement (e.g., sports), or for video content with slow movement (e.g., news).

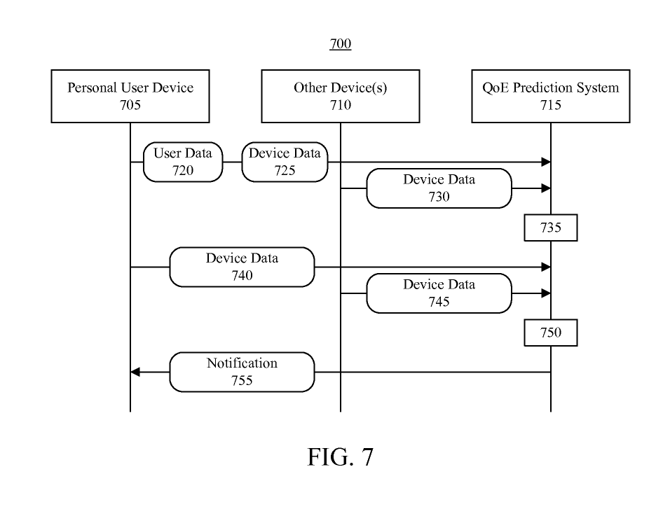

FIG. 7 is an exemplary message flow diagram 700 illustrating communication between devices and a QoE processing system (system). As pictured, a personal user device 705 provides user data 720 and device data 725 to system 715. For purposes of illustration, personal user device 705 may be any device through which a user may provide user data. For example, personal user device 705 may be a communication device such as a mobile phone executing a user data application through which a user may provide user preferences including real time user feedback. In another example, personal user device 705 may be a network-enabled appliance, e.g., a television, through which a user may provide user data such as user preferences including real time feedback. In addition, user data 720 may be provided from more than one personal user device. For example, user data 720 may be received from both a network-enabled appliance that the user is interacting with in addition to a communication device.

One or more other devices may provide device data 730 to system 715. In block 735, responsive to receiving user data 720 and device data 725 and/or 730, system 715 generates a QoE model. For example, system 715 implements a training process using the received data using a machine learning technique as described. It should be appreciated that while personal user device 705 and device(s) 710 both are shown to send device data, device data may only be received by system 715 from either one of personal user device 705 or device(s) 710.

Subsequent to generation of the QoE model, system 715 receives further device data 740 from personal user device 705 and/or further device data 745 from other device(s) 710. System 715 determines one or more predicted QoEs responsive to receiving device data 740 and/or device data 745. In one aspect, system 715 may continually receive device data and calculate QoEs responsive to receiving any new device data, periodically, from time-to-time, or responsive to a particular event such as a current QoE being below a particular threshold QoE level. System 715 sends a notification 755 to personal user device 705. As noted, notification 755 may be informative only, include executable instructions, and/or include one or more QoE maps, e.g., one or more of a QoE heat map, one or more of a QoE contour map, or one or more of both types of maps.

In a first exemplary use case, a user may be viewing streaming video content on personal user device 705. User data 720 may specify information such as a video streaming preference, e.g., an initial QoE preference for video streaming. Further, user data 720 may specify a real time QoE that the user enters into personal user device 705 while viewing the streaming video. The real time QoE may be specified as a mean opinion score (MOS). In another example, user data 720 may include one or more parameters determined using facial recognition software. For example, if the user is experiencing poor video quality, the user's facial expression may be interpreted as dissatisfied or sad, which is correlated with a lower MOS and, as such, a lower QoE than if the user's facial expression is interpreted as being satisfied or happy.

User data 720 may also include health data if the user is wearing one or more health sensors such as a heart rate monitor, a body temperature sensor, blood pressure monitor, or the like. The current heart rate, body temperature, and/or blood pressure may be compared with one or more baseline health metrics for the user specified in the user's profile. These baseline health metrics may be incorporated into the QoE model to aid in determining a predicted QoE. The location of the user also may be included within user data 720.

As noted, device data 725 may specify other data such as network data and/or application data. The application data, for example, may specify the type of content being viewed in terms of the motion that is displayed, e.g., fast, slow, or gentle video. Device data 730 may specify other data such as temperature, whether one or more other appliances are scheduled to begin operation and/or are operating, noise level, and the like. It should be appreciated that, at least in some cases, the device data may be restricted to a vicinity close to the location of the user, e.g., within a predetermined distance from the user. For example, noise levels may only be used for purposes of predicted QoE if from sensors located within a predetermined distance of the user, if from within a same room or adjoining room as the user, etc. In this regard, device data from one or more devices may be filtered out, or not used, for purposes of predicted QoE.

Notification 755 may specify that operation of one or more appliances should be postponed or deactivated (e.g., stopped). Notification 755 may specify that temperature should be adjusted within the dwelling. Notification 755 may specify that improved QoE may be obtained if personal user device 705 switches to a different communication channel, whether such switch is from a first WiFi network to a second and different WiFi network, from a mobile network to a WiFi network, or from a WiFi network a mobile network.

In a second use case, the user may be viewing video content on personal user device 705 and indicate dissatisfaction as part of user data 720 or further user data (not shown) sent after block 735. The further user data may be received from the user as real time user feedback indicating dissatisfaction. For example, the real time user feedback may be entered by the user directly into personal user device 705 or using any of the other data input mechanisms described herein. In that case, system 715 may instruct personal user device 705 to initiate a vertical handover process from the current communication channel to another communication channel over which the video content is also available and that maximizes predicted QoE for the user. Personal user device 705, responsive to the instruction, initiates the vertical handover process. The different communication channel may have significantly more bandwidth available than the current communication channel over which the video content is delivered.

In a third exemplary use case the user may be resting while viewing video content on personal user device 705. Personal device 705 may be a tablet or a network-enabled television. In this example, system 715 may receive a temperature reading for outside of the user's dwelling and an indication of user discomfort from one or more other devices 710. System 715 may determine from the QoE model, which is trained using, at least in part, the user's temperature preference for a comfortable indoor temperature while viewing video content, that the QoE for the user may be improved. For example, system 715 may determine that a predicted QoE, where the temperature matches the user preferred temperature, would be higher than a current QoE. System 715 may send a notification to the climate control system to raise or lower the indoor temperature as appropriate resulting in an improved QoE. Thus, system 715 may control the climate control system and send instructions to be implemented without requiring user involvement. In another aspect, however, system 715 may notify the user that the temperature requires adjusting. In still another aspect, system 715 may adjust temperature automatically as described, but only after providing a notification to the user requesting permission to adjust temperature and receiving approval from the user.

System 715 may provide further notifications, whether informative and directed to personal user device 705 or including executable instructions that are sent to other devices 710 that are under control, at least partially, of system 715. The further notifications may suggest or initiate the raising or lowering of shades, the turning on or off of other appliances according to ambient noise levels indoors, the adjustment of temperature and/or activation of a climate control system according to indoor humidity and the current activities of the user, etc.

In a fourth exemplary use case, other devices 710 may provide different types of device data 730 relating to security and/or safety. For example, other devices 710 may include power outage sensors, water leakage sensors, gas leakage sensors, smoke detectors (sensors), intruder sensors (e.g., alarm and/or security system), and the like sending device data 730. System 715 may create the QoE model using the device data 730. In one aspect, system 715 may evaluate device data 745 in a holistic manner rather than viewing each data item from each device independently.

For example, a power outage detector may detect a power outage while an intruder sensor may detect a break in or intruder. System 715 may evaluate the context of both events occurring concurrently with one another and determine that the most immediate concern is the break in based upon the QoE model. Accordingly, system 715 may immediately contact a local police station or other relevant authority rather than first trying to restore power. In this manner, system 715 may prioritize two or more concurrent events and take action on the highest priority event.

In a fifth exemplary use case, system 715 may adapt to changing needs of a user while still remaining under control of the user. System 715 may determine the location of the user within a structure and determine the user's activity, e.g., computing activity. System 715 may determine, for example, that the user is sending an e-mail including an attached file containing personal information of the user from a smart phone. The smart phone may be connected with a WiFi network. System 715 may instruct the smart phone to send the e-mail using a mobile or cellular network communication channel due to the higher security and encryption protocols used in mobile/cellular networks as compared to WiFi. The determination to instruct the smart phone as described may be performed using a QoE model that incorporates user privacy preferences relating to the handling of private information. In this manner, system 715 may perform actions to increase QoE as QoE pertains to user privacy. In another example, the smart phone may be instructed switch from WiFi to a Bluetooth connection with an edge device that has a wired connection to the modem and/or router using a vertical handoff procedure to avoid sending private data over a WiFi communication link.

In a sixth exemplary use case, system 715 may facilitate automatic content or information transfer based on the user location changes while the user is involved in certain activities. For example if the user is reading a book, useful information related to the book or author may be retrieved though an Internet search and displayed on the nearest user display screen automatically, or stored in the user's personal computer automatically. The concept of content transfer may also be extended into transferring the display content to the nearest display device as the user moves from one location to another.

In another example, user preferences may be customized on a per room or per location basis so that content may be transferred from one room to another, e.g., from a device in one room to a device in another, as the user moves from one room to another. The content may be transferred from one device to another in accordance with the user's per room and/or location preferences. For example, the user may be watching a news channel in the living room and move to the kitchen. The news channel may be sent to the user's smart phone in the kitchen so that the user may continue watching the news channel substantially uninterrupted.

In another example, the modality of the content may be changed as the user moves from one room to another. For instance, the user may initially be watching audiovisual material in a first room. As the user moves to the second room, the device available in the second room may only be operative for a different modality. For example, the device in the second room may only be operable to play audio material. Thus, the user is able to hear audio from the audiovisual material in the second room from the device that is available. Other exemplary modalities may include video, images, text, voice, audio, etc. The change in modality may be implemented by system 715 according to the capabilities of the nearest device, available bandwidth, or the like. For instance, system 715 may select a modality that consumes less bandwidth when less bandwidth is available or a modality that consumes greater bandwidth when more bandwidth is available.

As noted, the user preferences may also follow the user. Continuing with the prior example, the user may be viewing audiovisual content on a device in a first room. As the user moves to a second room, the same content may begin playing on a device in the second room uninterrupted, e.g., from the point in time that the user left the first room. System 715, for example, may send instructions to the device in the second room to begin playing the same content uninterrupted. If, for example, the washer or dryer is scheduled to start in a room adjacent to the second room and the user is still viewing the audiovisual material, system 715 may delay the start time of the washer and/or dryer until either the user has finished with the audiovisual content or has left the second room.

In a seventh exemplary use case, system 715 may determine that a communication link, e.g., a connection, utilized by a personal user device 705 is poor and provide specific suggestions as to where the user may move to improve the communication link. For example, responsive to determining that the QoE of the communication link with personal user device 705 is below a threshold, system 715 may identify one or more other locations near the user, e.g., within a predetermined distance of the user, that have a higher predicted QoE than the QoE of the communication link for the user's current location. System 715 may provide the user with specific instructions, within notification 755, to improve the communication link. The instructions may inform the user to move in a particular direction, take a particular number of steps or move a particular distance in a particular direction, move into a particular room of a structure in which the user is currently located, or the like.

The inventive arrangements disclosed herein provide methods, systems, and computer program products relating to generating a QoE model using both device data and user data. A predicted QoE may be determined based upon further received device data. Incorporation of the user data within the QoE model increases the accuracy of the QoE prediction over other techniques that rely solely upon objective data.

The computer program product may include a computer readable storage medium (or media) having computer readable program instructions thereon for causing a processor to carry out aspects of the present invention. Computer readable program instructions described herein may be downloaded to respective computing/processing devices from a computer readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations for the inventive arrangements described herein may be assembler instructions, instruction-set-architecture (ISA) instructions, machine instructions, machine dependent instructions, microcode, firmware instructions, state-setting data, or either source code or object code written in any combination of one or more programming languages, including an object oriented programming language and/or procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some cases, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the inventive arrangements described herein.

Certain aspects of the inventive arrangements are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by computer readable program instructions, e.g., program code.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the operations specified in the flowchart and/or block diagram block or blocks.

The computer readable program instructions may also be loaded onto a computer, other programmable data processing apparatus, or other device to cause a series of operations to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the inventive arrangements. In this regard, each block in the flowchart or block diagrams may represent a module, segment, or portion of instructions, which comprises one or more executable instructions for implementing the specified operations. In some alternative implementations, the operations noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

For purposes of explanation, specific nomenclature is set forth to provide a thorough understanding of the various inventive concepts disclosed herein. The terminology used herein, however, is for the purpose of describing particular aspects of the inventive arrangements only and is not intended to be limiting.

As defined within this disclosure, the terms “a” and “an” mean one or more than one. The term “plurality,” as defined herein, means two or more than two. The term “another,” as defined herein, means at least a second or more. The term “coupled,” as defined herein, means connected, whether directly without any intervening elements or indirectly with one or more intervening elements, unless otherwise indicated. Two elements may also be coupled mechanically, electrically, or communicatively linked through a communication channel, pathway, network, or system.

As defined herein, the term “automatically” means without user intervention. As defined herein, the term “user” means a human being. The term “and/or” as defined herein means any and all possible combinations of one or more of the associated listed items. The terms “includes” and/or “including,” when used in this disclosure, specify the presence of stated features, integers, steps, operations, elements, and/or components, but do not preclude the presence or addition of one or more other features, integers, steps, operations, elements, components, and/or groups thereof. Although the terms “first,” “second,” etc. may be used herein to describe various elements, these elements should not be limited by these terms, as these terms are only used to distinguish one element from another unless the context indicates otherwise.

As defined herein, the terms “if,” “when,” “upon,” mean in response to detecting and/or determining or responsive to detecting and/or determining. For example, the phrase “if [a stated condition or event] is detected,” means in response to determining and/or detecting [the stated condition or event].” As defined herein, the terms “in response to” and/or “responsive to” mean responding or reacting readily to an action, event, or condition. Thus, if a second action is performed “responsive to” a first action, there is a causal relationship between an occurrence of the first action and an occurrence of the second action, and the term “responsive to” indicates such causal relationship.

As defined herein, the term “computer readable storage medium” means a storage medium that contains or stores program code for use by or in connection with an instruction execution system, apparatus, or device. As defined herein, a “computer readable storage medium” is not a transitory, propagating signal per se. A computer readable storage medium may be, but is not limited to, an electronic storage device, a magnetic storage device, an optical storage device, an electromagnetic storage device, a semiconductor storage device, or any suitable combination of the foregoing. A non-exhaustive list of more specific examples of a computer readable storage medium may include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

As defined herein, the term “processor” means at least one hardware circuit (e.g., an integrated circuit) configured to carry out instructions contained in program code. Examples of a processor include, but are not limited to, a CPU, an array processor, a vector processor, a digital signal processor (DSP), an FPGA, a PLA, an application specific integrated circuit (ASIC), programmable logic circuitry, and a controller.

As defined herein, the term “real time” means a level of processing responsiveness that a user or system senses as sufficiently immediate for a particular process or determination to be made, or that enables the processor to keep up with some external process.

The description of the inventive arrangements provided herein is for purposes of illustration and is not intended to be exhaustive or limited to the form and examples disclosed. Modifications and variations may be apparent to those of ordinary skill in the art without departing from the scope and spirit of the described inventive arrangements. The terminology used herein was chosen to explain the principles of the inventive arrangements, the practical application or technical improvement over technologies found in the marketplace, and/or to enable others of ordinary skill in the art to understand the embodiments disclosed herein.

What is claimed is:

1. A method, comprising:
continuously receiving device data;
receiving user data;
generating, using a processor, a Quality of Experience (QoE) model using the device data and the user data;
determining, using the processor, a predicted QoE using the QoE model; and
providing a notification for improving a current QoE from the predicted QoE.

2. The method of claim 1, wherein receiving user data comprises:
receiving an initial user preference;
wherein the QoE model is dependent upon the initial user preference.

3. The method of claim 1, wherein receiving user data comprises:
receiving user feedback in real time;
wherein the QoE model is dependent upon the user feedback.

4. The method of claim 1, wherein the notification comprises a plurality of predicted QoEs and each predicted QoE is location specific.

5. The method of claim 1, wherein:
the user data comprises a streaming state of content delivered to a device; and
the device data comprises network data.

6. The method of claim 1, wherein:
the user data comprises a user sound level preference; and
the device data comprises a measured sound level.

7. The method of claim 1, wherein:
the user data comprises a user temperature preference; and
the device data comprises a measured temperature.

8. The method of claim 1, wherein:
the user data comprises a user lighting preference; and
the device data comprises a lighting level.

9. The method of claim 1, wherein the QoE model comprises a decision tree.

10. The method of claim 1, wherein:
the current QoE is specific to a first communication channel;
the predicted QoE is specific to a second communication channel different from the first communication channel;
the predicted QoE exceeds the current QoE; and
the notification comprises performing a handoff from the first communication channel to the second communication channel.

11. A system, comprising:
a processor programmed to initiate executable operations comprising:
continuously receiving device data;
receiving user data;
generating a Quality of Experience (QoE) model using the device data and the user data;
determining a predicted QoE using the QoE model; and
providing a notification for improving a current QoE from the predicted QoE.

12. The system of claim 11, wherein receiving user data comprises:
receiving an initial user preference;
wherein the QoE model is dependent upon the initial user preference.

13. The system of claim 11, wherein receiving user data comprises:
receiving user feedback in real time;
wherein the QoE model is dependent upon the user feedback.

14. The system of claim 11, wherein the notification comprises a plurality of predicted QoEs and each predicted QoE is location specific.

15. The system of claim 11, wherein:
the current QoE is specific to a first communication channel;
the predicted QoE is specific to a second communication channel different from the first communication channel;
the predicted QoE exceeds the current QoE; and
the notification comprises performing a handoff from the first communication channel to the second communication channel.

16. A computer program product comprising a computer readable storage medium having program code stored thereon, the program code executable by a processor to perform a method comprising:
continuously receiving device data using the processor;
receiving user data using the processor;
generating, using the processor, a Quality of Experience (QoE) model using the device data and the user data;
determining, using the processor, a predicted QoE using the QoE model; and
providing, using the processor, a notification for improving a current QoE from the predicted QoE.

17. The computer program product of claim 16, wherein receiving user data comprises:
receiving an initial user preference;
wherein the QoE model is dependent upon the initial user preference.

18. The computer program product of claim 16, wherein receiving user data comprises:
receiving user feedback in real time;
wherein the QoE model is dependent upon the user feedback.

19. The computer program product of claim 16, wherein the notification comprises a plurality of predicted QoEs and each predicted QoE is location specific.

20. The computer program product of claim 16, wherein:
the current QoE is specific to a first communication channel;
the predicted QoE is specific to a second communication channel different from the first communication channel;
the predicted QoE exceeds the current QoE; and
the notification comprises performing a handoff from the first communication channel to the second communication channel.
